(19) United States
(12) Patent Application Publication
(10) Pub. No.: US 2005/0272515 A1
(43) Pub. Date: Dec. 8, 2005

(54) Golf flagstick assembly and method of joining

(75) Inventors: Matthew L. Hurley, Cedar Falls, IA (US); Ron L. Saul, Cedar Falls, IA (US); Scott M. Hottle, Waterloo, IA (US)

Correspondence Address: MCKEE, VOORHEES & SEASE, P.L.C., 801 GRAND AVENUE, SUITE 3200, DES MOINES, IA, 50309-2721, US

(73) Assignee: Standard Golf Company, Cedar Falls, IA (US)

(21) Appl. No.: 10/861,159

(22) Filed: Jun. 4, 2004

(51) Int. Cl. A63B 69/36; A63B 57/00; G09F 17/00

(52) U.S. Cl. 473/173; 473/174; 473/176; 116/173

(57) ABSTRACT

A golf flagstick assembly includes a flagstick and an accessory aligned substantially straight with each other along a common longitudinal centerline. The flagstick and the accessory are rapidly joined together utilizing crimps upon the accessory which engage the flagstick. The accessory may be joined to the golf flagstick assembly at either end or between the ends. The method includes the steps forming an assembly by placing the rod within the accessory and joining in alignment the assembly by crimping the accessory at balanced locations around a circumference of the accessory to press against the flagstick.

### BACKGROUND OF THE INVENTION

The present invention relates generally to the field of golf course accessories and, more particularly, to a golf flagstick assembly and method of joining the same.

In prior art golf flagsticks, adhesive is used for joining a golf flagstick to an accessory placed upon the golf flagstick. Adhesive creates a number of problems and difficulties. Adhesive is difficult to place within the interface between the rod and the accessory, requires a curing time for the adhesive to set, and the prior art flagsticks provide no structure for positively aligning the golf flagstick with the accessory.

The prior art golf flagstick assemblies did not require accurate alignment of golf stick accessories and flagsticks. Instead, the prior art was largely concerned with securing the accessory to the flagstick costs and therefore did not invest into the development and equipment for precise alignment of golf flagsticks. Moreover, the requirement for precisely aligned golf flagstick assemblies was not evident until precision distance measuring tools were available that utilized accessories for laser sighting placed upon the golf flagstick. This type of accessory requires a very straight golf flagstick assembly. The accessory may also require being placed between a golf flagstick rod that has been divided into a first second and a second section. In such a case the golf flagstick may have three joints in which a first joint is between a golf ferrule and the golf flagstick rod, a second joint is between a first section of the golf flagstick and the center mounted accessory, and a third joint is between the second section of the golf flagstick rod and the center mounted accessory. With several joints, the cumulative affects of using adhesive at these joints may create a misaligned golf flagstick assembly.

Therefore, a primary objective of the present invention is a provision of an improved golf flagstick assembly and method of joining the same.

A further objective of the present invention is a provision of a golf flagstick assembly and method for joining the same that is efficient in operation, economical to manufacture and durable in use.

### SUMMARY OF THE INVENTION

The foregoing objectives may be achieved by a golf flagstick assembly that has a flagstick rod and an accessory that are both substantially straight and joined together rapidly such that flagstick rod and accessory are substantially aligned.

The foregoing objectives may also be achieved by a golf flagstick assembly that includes a golf flagstick with a ferrule attached that is adapted for placement into a putting cup. The flagstick is substantially straight and has a longitudinal centerline and the ferrule has a body and a sleeve that is substantially straight and has a longitudinal centerline. The flagstick and the ferrule joined together by a plurality of crimps upon the sleeve that engage the flagstick such that the flagstick's longitudinal centerline and the sleeves longitudinal slant centerline are substantially aligned.

According to another feature of the present invention, the golf flagstick assembly may have an accessory attached upon the flagstick by a plurality of crimps that align a longitudinal centerline of accessory with a longitudinal centerline of the flagstick.

According to another feature of the invention the accessory may be joined to the flagstick assembly at either end or between the ends.

According to another feature of the present invention, the golf flagstick assembly may utilize a flagstick that has a first section and a second section joined together by an accessory between the first section and the second section.

According to another features of the present invention, the method of joining provides a secure attachment that provides an accurate method of centering an accessory onto a flagstick rod.

According to another feature of the present invention, the method eliminates nuisance fiberglass dust during the attachment process which may create a problem on some joining applications.

According to another feature of the present invention, the method provides for the removal of the connection between the flagstick rod and the accessory with relative ease and to optionally place upon another flagstick rod.

According to another feature of the present invention, adhesive may be used in addition to the crimping method for extra measure strength.

The foregoing objective of the present invention may also be achieved by a method of joining a golf flagstick assembly.

The method generally comprises the steps of providing an attachment piece and a flagstick rod, forming an assembly by placing the flagstick rod into a sleeve of the attachment piece, and then joining in alignment the assembly by crimping the sleeve against the rod simultaneously from equally spaced locations around a circumference of the sleeve.

### BRIEF DESCRIPTION OF THE DRAWINGS

FIG. 1 is a perspective view of the golf flagstick assembly in position over a golf putting cup in a putting green.

FIG. 2 is a side view of the golf flagstick assembly of FIG. 1 showing a golf stick accessory mounted upon the golf flagstick assembly.

FIG. 3 is a cross-sectional view taken along line 3-3 of FIG. 2.

FIG. 4 is a close up view of section 4-4 of FIG. 3.

FIG. 5 is a side view of the prior art golf flagstick utilizing adhesive to join the golf flagstick rod with the accessory.

FIG. 6 is a cross-sectional view taken along line 6-6 of FIG. 5.

FIG. 7 is a close up view of section 7-7 of FIG. 6.

FIG. 8 is a perspective view of a golf flagstick assembly prior to crimping by a crimping apparatus utilizing punches.

FIG. 9 is a perspective view of the flagstick of FIG. 8 with the accessory attached to the flagstick rod by crimps.

FIG. 10 is an exploded perspective view of a golf flagstick assembly with an accessory attached to the tip of the flagstick.

### DETAILED DESCRIPTION OF THE PREFERRED EMBODIMENT

The present invention will be described as it applies to its preferred embodiment. It is not intended that the present invention be limited to the described embodiment. It is intended that the invention covers all alternatives, modifications, and equivalents which may be included within the spirit and scope of the invention.

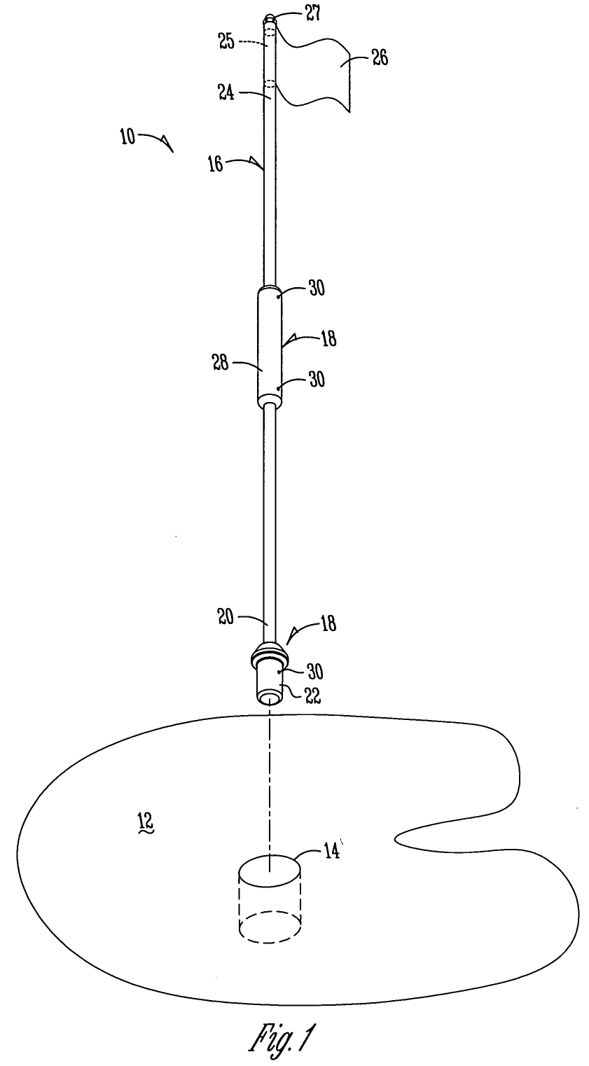

FIG. 1 shows the golf flagstick assembly 10 of the present invention. The golf flagstick assembly 10 is shown in use on a putting green 12 that has a golf putting cup 14 located upon it.

The golf flagstick assembly 10 has a golf flagstick 16 with attachment piece or accessory 18 located upon it.

The golf flagstick has a first end 20 having an attachment piece 18 that is a ferrule 22. The ferrule 22 is designed to mate with the golf putting cup 14 to maintain the golf flagstick assembly 10 perpendicular with a plane defined by the top of the opening of the putting cup 14.

The golf flagstick 16 has a second end 24 upon which a flag 26 is positioned.

Upon the center of the golf flagstick 16 is an attachment piece 18 called a rod accessory 28. One use of the rod accessory 28 is to cooperate with a laser distance sighting system (not shown). The rod accessory 28 may be sized to fit a variety of different flagsticks 16 that may range in size from ½ inch in diameter to 1 inch in diameter. The rod accessory 28 may have a variety of different heights but when used with a laser distance sighting system is typically between 2 inches to 5 inches tall.

The flagstick 16 may be made of a variety of different materials but is typically made of fiberglass. Both the ferrule 22 and the rod accessory 28 are attached to the golf flagstick 16 by crimps 30. Both the ferrule 22 and the rod accessory 28 are made of plastic, aluminum or other malleable material. The crimps 30 are formed in the ferrule 22 and the rod accessory 28 by forcing a crimping apparatus upon it which forces the metal to crimp or dimple downward to engage the flagstick 16 positioned underneath the crimp 30.

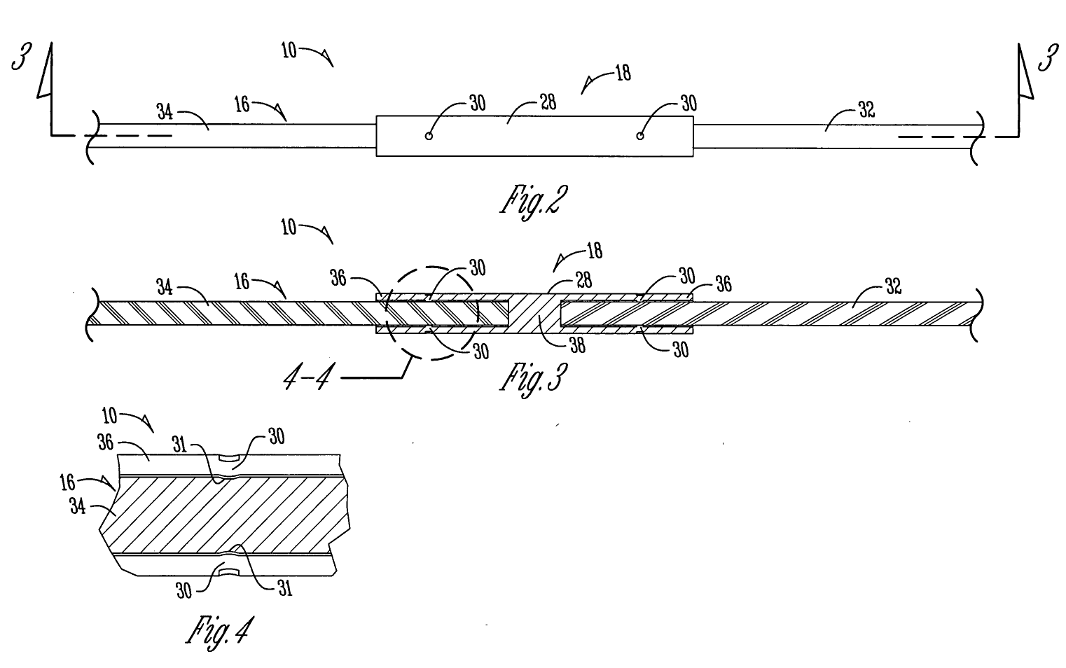

As seen in FIG. 2, a side view of the attachment piece 18 illustrated as a rod accessory 28 is shown. The crimps 30 are applied upon the attachment piece 18 at a position perpendicular the centerline of the golf flagstick 16. As shown in FIG. 3, two crimps 30 are equally spaced around a circumference of the attachment piece 18. Alternatively, the crimps may be placed in balanced locations around a circumference; for example, three punches may be used with two punches 100 degrees, and the third punch 130 degrees from the second punch. It is to be understood that the phrase balanced locations includes locations that achieve securing and centering of the accessory 18 to the flagstick 16. Dimple-like crimps 30 are shown being used. The crimps 30 typically number between two and six. The number of crimps 30 may be an even number or an odd number as long as they are equally spaced around a circumference of the attachment piece. Typically, the number of crimps ranges between two to six. Therefore, if two locations are utilized, they should be spaced 180° apart, if three locations are utilized, they should be spaced 120° apart, etc. The crimps may be in a common plane around the circumference of the accessory or may offset to be in a non-common plane.

As shown in FIG. 3, the flagstick 16 has a first section 32 and a second section 34. The accessory 18 has opposing sleeves 36 and a body 38. The first section 32 fits into sleeve 36 and the second section 34 fits into a second opposite sleeve 36. The sections 32, 34 are held in alignment with the accessory 18 along a common longitudinal centerline. Although the flagstick 16 is shown having a first section 32 and a second section 34, it is to be understood that the accessory 18 may be slid upon a flagstick that does not have two separate sections.

FIG. 4 is an enlarged view of the crimps 30 formed in the sleeve 36 of the rod accessory 28 and engaging the rod 34. As illustrated, the crimps 30 create a slight impression 31 on the flagstick 16.

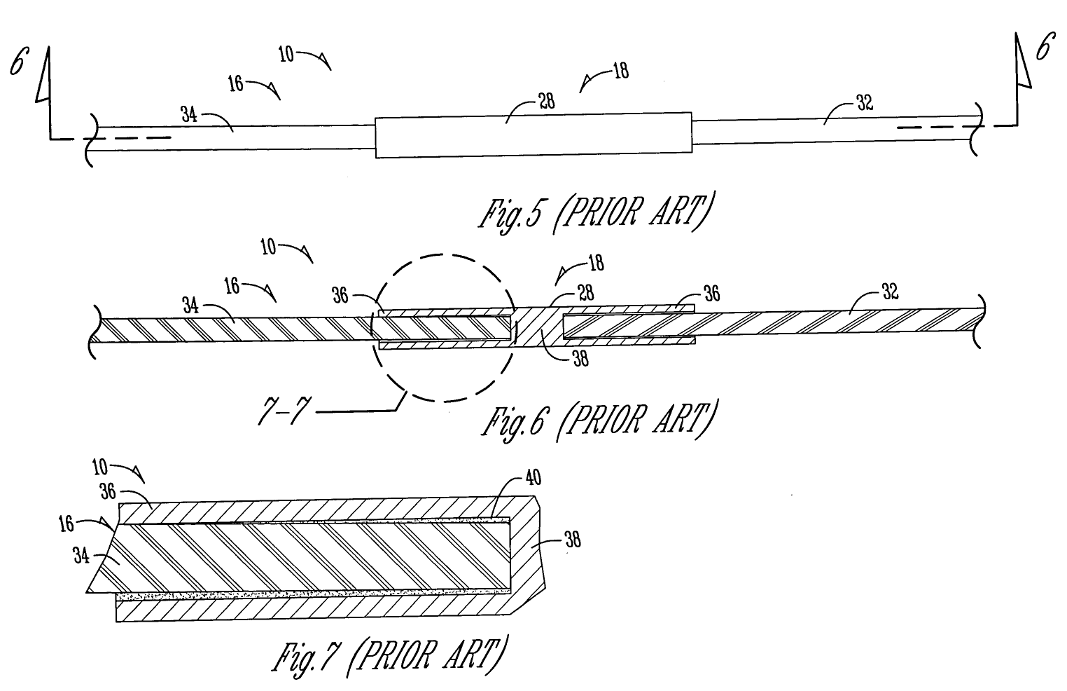

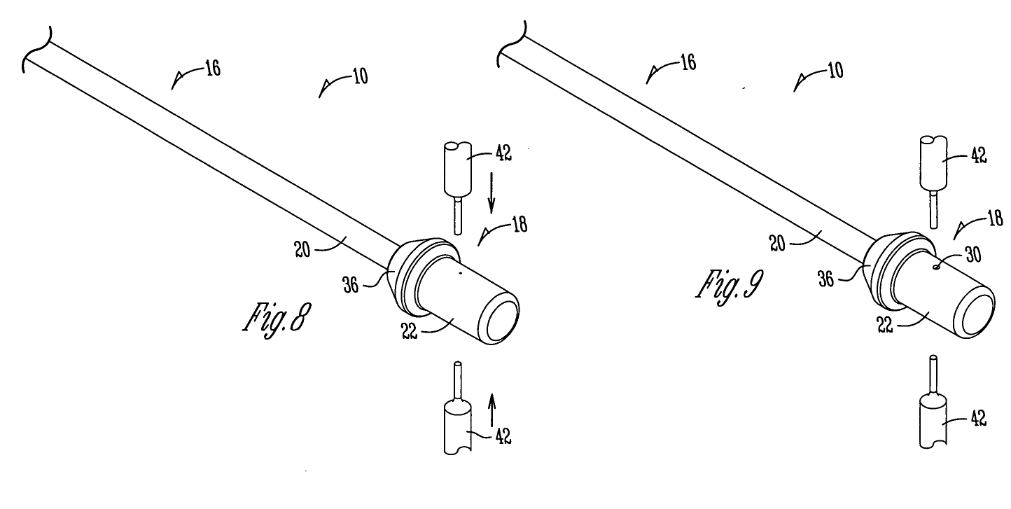

FIGS. 5-7 illustrate the prior art use of adhesive to hold the flagstick 16 and the accessory 18 together. As shown, the flagstick 16 may become crooked or misaligned within the sleeve 36. The misalignment may occur because of the effects of gravity. The misalignment may occur regardless of the angle the assembly 10 is held to cure or dry. With the prior art system, the misalignment may be ameliorated by significant external clamping over the long period of time required for the adhesive to set. The misalignment is further complicated by the fact that the sleeve is often formed with a larger diameter than necessary in order to permit placement of adhesive between the interface of the rod 34 and the sleeve 36.

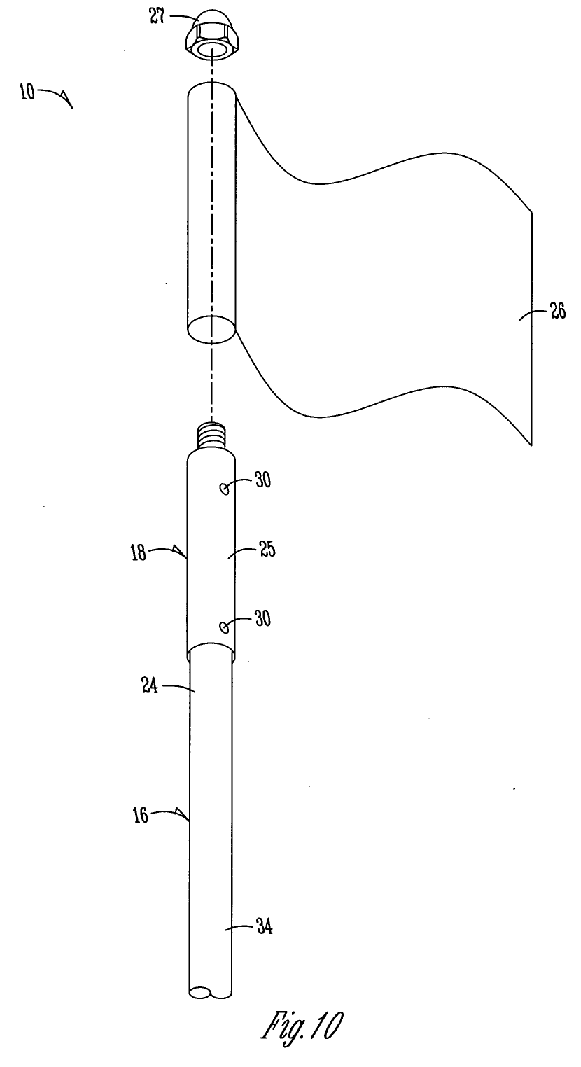

As seen in FIGS. 8 and 9, in use the accessory 18 which in these figures is a ferrule 22 is affixed to the fiberglass rod by creating a number of small crimps or dimples 30 in the accessory 18. As illustrated, a round punch 42 is used making a round impression. Alternatively, a square or other shaped punch 42 may be used to form square or other shaped dimples 30. These dimples engage the first end 20 of the golf flagstick 16 to substantially align the flagstick 16 and the ferrule 22 along a common longitudinal centerline. As illustrated, the number of dimples 30 is at least two 180° apart but may alternatively have three to six dimples 30.

As seen in FIG. 10, the crimping method may be used with an accessory 18 at the top end 24 of the flagstick 16 to form golf flagstick assembly 10. The crimps 30 provide sufficient attachment to bind accessories 18 to the flagstick 16 independent of locations on the flagstick 16.

In use, the beginning step of the method is that the accessory 18 is placed upon the golf flagstick 16 to form an assembly 10. This assembly 10 is then placed into jaws (not shown) machined to hold the accessory 18 firmly. Each specific component requires jaws manufactured for the specific application so that the accessory is held firmly in place upon the golf flagstick 16 with the accessory 18 maintained in accurate alignment along a common longitudinal centerline during the attachment process.

Next, the assembly is joined in alignment by actuating a cylinder that builds pressure and forces punches 42 into the accessory 18. The force of the punches 42 on the exterior of the accessory 18 compresses the inside dimension of the accessory 18 onto the golf flagstick 16. This, in effect, squeezes the accessory 18 onto the rod, holding it firmly in place. The punches 42 leave a crimp or dimple 30 in the face of the accessory 18. This crimp 30 is evidence that the accessory 18 has been moved into contact with the flagstick 16 and is useful for quality inspection purposes.

After the cycle has been actuated, the punches 42 are cycled and the cylinder returned to complete the cycle. Depending on the application, additional cycles may be completed upon the same golf accessory 18. To permit maximum alignment between the flagstick 16 and the accessory 18, punches 42 are spaced at 180° from one another. Alternatively, a plurality of punches greater than two may compress the accessory 28 onto the flagstick 16. When securing the accessory 18 to the flagstick 16, it is important to press them at balanced locations around the circumference of the sleeve 36. The crimping may be at equally spaced locations or balanced locations to substantially align the flagstick 16 and accessory 18 along a common longitudinal centerline.

This crimping process may be done to accessories 18 positioned at an end of the flagstick 16 in which only one sleeve 36 has dimples 30 applied to it or within the center of the rod 16 in which may use two sleeves 36 have dimples 30 applied to it.

An additional step may utilize removing the crimped joint by using a boring tool such as one using a drill bit larger than the crimped dimples 30. Once this hole has been drilled the assembly 10 made of the flagstick 16 and the accessory 18 may be separated and then each reused.

Additionally, the assembly may utilize an adhesive applying step which places adhesive within the interface of the sleeve and the flagstick 16. Using adhesive makes it virtually impossible to remove the accessory from the flagstick and provides an extra measure of strength. The adhesive used in combination with the dimples 30 permits the adhesive to set up with the flagstick and the accessory 18 in substantial alignment along a common longitudinal centerline. In this fashion, the crimps 30 not only may secure the accessory 30 to the flagstick 16 but also serve as internal clamping while the adhesive sets.

1. A golf flagstick assembly, comprising:
a flagstick having a first end and a second end;
wherein the flagstick is substantially straight and has a longitudinal centerline;
an accessory having a body and a sleeve;
wherein the sleeve is substantially straight and has a longitudinal centerline;
the flagstick and the accessory rapidly joined together such that the flagstick's longitudinal centerline and the sleeve's longitudinal centerline are substantially aligned.

2. The golf flagstick assembly of claim 1 wherein the accessory is joined to the flagstick by a plurality of crimps upon the sleeve that contact the flagstick.

3. The golf flagstick assembly of claim 2 wherein the crimps are equally spaced around the circumference.

4. The golf flagstick assembly of claim 3 wherein the plurality of crimps number between 2 and 6.

5. The golf flagstick assembly of claim 1 wherein the accessory is a ferrule attached to the first end and adapted to be inserted into a golf putting cup.

6. The golf flagstick assembly of claim 1 wherein the accessory is attached between the first and second ends of the flagstick.

7. The golf flagstick assembly of claim 6 wherein the flagstick has a first section and a second section, the accessory positioned between the first and second sections.

8. The golf flagstick assembly of claim 1 further comprising adhesive in an interface between the flagstick and the accessory.

9. A golf flagstick assembly, comprising:
a golf flagstick having a first end having a ferrule adapted for placement into a putting cup and a second end having a flag attached;
wherein the flagstick is substantially straight and has a longitudinal centerline;
the ferrule having a body and a sleeve;
wherein the sleeve is substantially straight and has a longitudinal centerline;
the flagstick and the ferrule joined together by crimps upon the sleeve that engage the flagstick such that the flagstick's longitudinal centerline and the sleeve's longitudinal centerline are substantially aligned.

10. The golf flagstick assembly of claim 9 further comprising an accessory having at least one sleeve attached between the first and second ends of the flagstick by a plurality of crimps that align a longitudinal centerline of the accessory with the longitudinal centerline of the flagstick.

11. The golf flagstick assembly of claim 10 wherein the accessory has a first sleeve, a second sleeve, and a body therebetween, the flagstick having a first section and a second section, the accessory joined to the first and second sections by crimps upon the first and second sleeve.

12-19. (canceled)
